(19) United States
(12) Patent Application Publication
(10) Pub. No.: US 2018/0082057 A1
(43) Pub. Date: Mar. 22, 2018

(54) ACCESS CONTROL

(71) Applicant: Intel Corporation, Santa Clara, CA (US)

(72) Inventors: Michael LeMay, Hillsboro, OR (US); David M. Durham, Beaverton, OR (US); Ravi L. Sahita, Portland, OR (US)

(73) Assignee: Intel Corporation, Santa Clara, CA (US)

(21) Appl. No.: 15/273,286

(22) Filed: Sep. 22, 2016

(51) Int. Cl. G06F 21/54

(52) U.S. Cl. CPC G06F 21/54; G06F 2221/033

(57) ABSTRACT

Technologies are provided in embodiments to provide access control for applications in a computing environment. Particular embodiments are configured to identify a code region of a code segment in an application, determine a resource to be allocated to the code region, and prior to the application execution, authorize the code region to access the resource during an execution of the code region. In specific embodiments, authorizing the code region includes embedding at least one token in the code region. In other specific embodiments, authorizing the code region includes associating an identity of the code region with the resource. In further embodiments, when the compiled application is executed, a segment load instruction associated with the resource is to attempt to verify the code region is authorized to access the resource, and allow execution of the code region based, at least in part, on the verification.

### TECHNICAL FIELD

This disclosure relates in general to the field of information security, and more particularly, to providing access control in a computing environment.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, assisting with distributed denial of service attacks, sending out spam or malicious emails from the host computer, etc. Hence, significant administrative challenges remain for protecting computers and computer networks from malicious and inadvertent exploitation by malicious software.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system to provide access control in accordance with an embodiment of the present disclosure;

FIG. 2A is a simplified block diagram illustrating example details of a portion of a communication system to provide access control, in accordance with an embodiment of the present disclosure;

FIG. 2B is a simplified block diagram illustrating example details of a portion of a communication system to provide access control, in accordance with an embodiment of the present disclosure;

FIG. 3A is a simplified block diagram illustrating example details of a portion of a communication system to provide access control, in accordance with an embodiment of the present disclosure;

FIG. 3B is a simplified block diagram illustrating example details of a portion of a communication system to provide access control, in accordance with an embodiment of the present disclosure;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a simplified flowchart illustrating potential operations that may be associated with the communication system in accordance with an embodiment;

FIG. 7 is a simplified flowchart illustrating potential operations that may be associated with the communication system in accordance with an embodiment;

FIG. 8 is a block diagram illustrating an example computing system that is arranged in a point-to-point configuration in accordance with an embodiment;

FIG. 9 is a simplified block diagram associated with an example system on chip (SOC) of the present disclosure; and

FIG. 10 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EMBODIMENTS

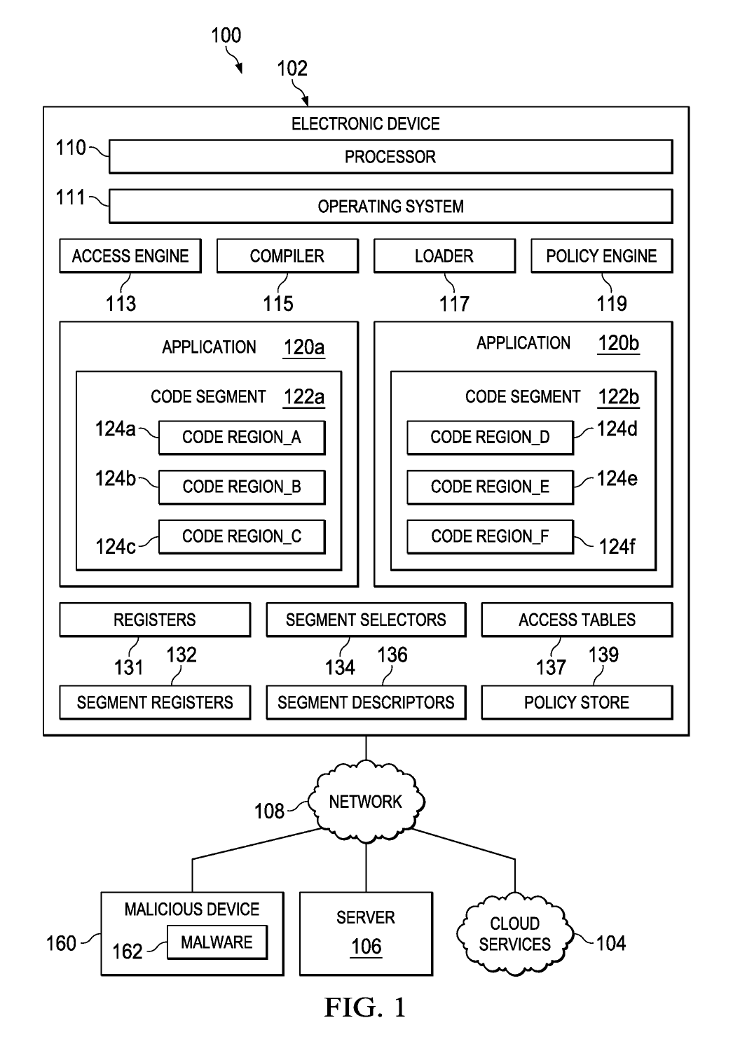

FIG. 1 is a simplified block diagram of a communication system 100 illustrating example details of access control, in accordance with an embodiment of the present disclosure. As illustrated in FIG. 1, an embodiment of communication system 100 can include an electronic device 102, cloud services 104, and a server 106. Electronic device 102 can include a processor 110, an operating system 111, an access engine 113, a compiler 115, a loader 117, and a policy engine 119. Electronic device 102 may also include one or more applications, represented by applications 120a and 120b. Each application may include one or more code segments as illustrated by code segment 122a in application 120a and code segment 122b in application 120b. Each code segment of an application can include one or more code regions. By way of example, code segment 122a is illustrated with code region_A 124a, code region_B 124b, and code region_C 124c, while code segment 122b is illustrated with code region_D 124d, code region_E 124e, and code region_F 124f. Electronic device 102 can further include one or more registers 131, one or more segment registers 132, one or more segment selectors 134, one or more segment descriptors 136, one or more access tables 137, and a policy store 139. Electronic device 102, cloud services 104, and server 106 may be in communication using network 108. In an example, malicious device 125 can attempt to infect electronic device 102 using malware 126.

Elements of FIG. 1 may be coupled to one another through one or more interfaces employing any suitable connections (wired or wireless), which provide viable pathways for network (e.g., network 108) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from the host computer, etc. One particular issue with malware is that it often accesses memory regions to obtain private data or to install itself to infect the host computer. Generally, a program (also referred to herein as an ‘application’) should only be permitted to access certain memory regions.

Currently, most systems distinguish access requests based on the ring level of code issuing the request. However, this is too coarse to enforce varying access control within a single program. For example, a cryptographic (or crypto) key should only be accessible to the crypto library routine that needs it. Likewise, password data should only be accessible to as small a portion of the program as possible, to avoid leakage and exploitation by malware. It could also be beneficial if a system selectively permitted updates to privileged data structures such as descriptor tables and page tables from unprivileged ring levels. Currently, some processors do not support any type of privilege levels. Other processors support privilege levels where a segment load instruction only checks a current privilege level (CPL) against a descriptor privilege level (DPL). Likewise, updates to system data structures are restricted based on privilege levels and permission specifications in system data structures such as segment descriptors and page tables. This necessitates relatively slow privilege level transitions to perform privileged operations. What is needed is a system to control access to memory regions such that only particular portions of code in a program are allowed to access certain memory regions.

A communication system configured to provide access control, as outlined in FIG. 1 can resolve these issues (and others). In at least one embodiment, communication system 100 can identify one or more code segments in an application, identify a plurality of code regions within each identified code segment, and determine which resources (if any) are to be allocated to each of the code regions. Based on determining one or more resources are to be allocated to a code region, the code region can be authorized to access those resources. In one example, authorizing the code region includes embedding tokens as one or more immediate values in the code region. In another example, authorizing the code region to access a resource includes marking the code region based on its identity to indicate that the code region is authorized to access the resource. Authorization may occur at any suitable time based on particular needs. In at least one embodiment, the application may be compiled with authorized code regions. In at least one other embodiment, the authorizations may be provided during load time of an application to be executed.

Communication system 100 can also perform checks on a compiled application. When a processor sets the code of the compiled application to execute, the processor may not allow the code to execute if any of the code regions that are authorized to access one or more resources do not conform to a policy. When the application is executing, instructions in the compiled code can verify a code region is authorized to access a memory region containing a resource. The verification can be based on one or more embedded tokens in the code region or on the identity of the code region. In an embodiment using embedded tokens, an authentication value can be derived based on the one or more tokens. The authentication value can be compared to an expected value to verify that the code region is authorized to access a particular resource. In an embodiment using a segment code identity associated with a resource, the segment code identity can be used to determine if the code region has been marked in the code or in a policy structure as being authorized to access the resource. The check for the token(s) or for the code region identity can be performed when loading a segment descriptor of the resource into a segment register or when editing a privileged data structure. If the verification is successful, the code region may be allowed to execute. If the verification fails, then the code region may be blocked from executing.

Several advantages are provided by communication system 100. Embodiments providing access control, as described herein, do not require expensive context switching that typically occurs when an application is divided into multiple processes and resources are allocated to those processes. Embodiments described herein effectively isolate code regions from each other with respect to allocated resources, while exhibiting significantly less overhead and switching than is common with applications divided into multiple processes. Thus, with communication system 100, the overhead/cost of switching between multiple processes can be avoided.

Embodiments described herein can also minimize or eliminate the need to invoke the operating system (OS) or virtual machine monitor (VMM) to perform peripheral device accesses, which reduces overhead. Typically, when an application needs to communicate with a peripheral device (e.g., network controller), memory-mapped input output (IO) and/or direct memory access (DMA) is used. Such memory regions are usually marked as inaccessible from an application, because only the OS kernel is permitted to access them. In at least one embodiment, however, the OS could authorize a trusted code region to access those memory regions by embedding a token into the trusted code region that specifies the privileged data memory regions that the associated instruction can access. The OS could verify that only approved tokens are present in the application before starting to execute it. This general approach could be applied to either guest-level or host-level (VMM-level) peripheral device interactions in a virtualized system. The unprivileged software could be either a user-level application or a guest OS in a virtualized system.

Turning to the infrastructure of FIG. 1, communication system 100 in accordance with an example embodiment is shown. Generally, communication system 100 can be implemented in any type or topology of networks. Network 108 represents a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic device 102, cloud 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic device 102, cloud 104, and server 106 can include memory elements (e.g., memory 112) for storing information to be used in the operations outlined herein. Each of electronic device 102, cloud 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic device 102, cloud 104, and server 106 may include software modules (e.g., access engine 120) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic device 102, cloud 104, and server 106 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic device 102 can be a network element including, but not limited to, desktop computers, laptop computers, mobile devices, personal digital assistants, smartphones, tablets, or other similar devices. Cloud 104 can be configured to provide cloud services to electronic device 102. Cloud services may generally be defined as the use of computing resources that are delivered as a service over a network, such as the Internet. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication system 100.

Electronic device 102 is an example device illustrating the various components that may be provided in at least one embodiment for providing access control in applications. For ease of illustration and description, components to achieve both the generation of a compiled application with access control and the loading and execution of the compiled application with access control are illustrated in and described with reference to electronic device 102. It will be apparent however, that the generation of a compiled application with access control and the loading and execution of the compiled application with access control may be discrete functions and performed on different entities (e.g., different devices or network elements, different virtual machines, different virtual machines provisioned in a single device, etc.).

Electronic device 102 can include one or more applications. Applications 120a and 120b are representative of applications that could be provisioned on electronic device 102. An application is intended to include a program or group of programs designed to perform one or more functions when executed by one or more processors. Applications can include programs for end users (e.g., database programs, word processors, web browsers, spreadsheets, gaming applications, presentation software, etc.) and systems software (e.g., utilities for managing resources, etc.). An application can include one or more code segments, and each code segment can include one or more code regions.

A code segment is a section of memory that contains instructions to be executed to perform one or more functions. Each code region in a code segment can include instructions for a particular function (or functions) or a portion of a function. Applications can also include data segments. A data segment is a section of memory that contains data (e.g., constants, global and static variables, work areas, etc.). An application may include sensitive data segments and/or non-sensitive (or ordinary) data segments.

Some code regions contain instructions for accessing resources. As used herein, a ‘resource’ is intended to include any data to which access control is desired including, but not limited to, sensitive data, configuration data that controls execution of an application, privileged data structures, and/or any ordinary or other special data to which access control is desired. Examples of resources include, but are not limited to, cryptographic keys (e.g., to authenticate another program or function), password data, page table entries, etc. Resources accessed by code regions in an application may be provided in particular data segments.

Segment descriptors 136 and corresponding segment selectors 134 are created for data and code segments. A segment descriptor provides information to the processor to translate a logical address of code or data to a linear address, so that the code or data can be located. Each segment descriptor is associated with a segment selector that identifies the descriptor. The segment selector can identify its associated segment descriptor by specifying a descriptor table and indexing the segment descriptor stored in the descriptor table. Each code region may correspond to a segment descriptor and associated segment selector for code (or instructions). For a code region, one or more segment descriptors and associated segment selectors may indicate respective resources to be allocated to the code region so that the code region can access the resources during execution.

Segment selectors 134 and their associated segment descriptors 136 can be loaded into segment registers 132 as a result of various segment load instructions. Examples of segment load instructions include, but are not limited to, MOV (move data), POP (pop a word from the stack), and LGS/LSS/LDS/LFS (load full pointer). Segment load instructions also include control transfer instructions that use gates, such as JMP (jump) and CALL (call procedure). Generally, a segment load instruction is provided prior to instructions of a code region that accesses a resource. The segment load instruction loads a segment register with a selector and associated descriptor information for the data segment that contains the resource.

Access engine 113 may be provisioned in electronic device 102 to provide access control to an application in accordance with at least one embodiment. Access engine 113 may be configured to identify one or more code segments in an application, identify at least one code region within each identified code segment in the application, and determine resources to be allocated to the identified code regions. The access engine 113 may also authorize each code region to which a resource is to be allocated, access to that resource. In at least one embodiment, access engine 113 functions may be provisioned in compiler 115 and performed when an application is being compiled into an executable form. In other embodiments, one or more functions of access engine 113 may be performed by operating system 111. For example, loader 117 can be part of operating system 111 and may be configured to authorize code regions of a compiled application to access resources.

In some embodiments, one or more tokens may be embedded into a code region of an application during the process of authorizing the code region to access a particular resource. Subsequently, the one or more tokens embedded in the code region may be used during execution of the application to derive an authentication value to verify that the code region is authorized to access the resource. As used herein, a ‘token’ is intended to include any value that can be used as an authentication value to verify a code region is authorized to access a particular resource, or that can be used to compute or derive an authentication value.

Embodiments described herein can be implemented using non-secret tokens or secret tokens, based on particular needs and/or implementations of communication system 100. Various techniques may be used to protect tokens embedded in an application in order to prevent the tokens from being discoverable and/or usable by an adversary or malware. Such protection can prevent the tokens from being reused to gain unauthorized access to resources. For embodiments using secret tokens, the plaintext of a token is kept secret from other parts of the application, including malware that may be attempting to discover the plaintext of the token. For example, special encodings such as encryption may be used to maintain the secrecy of the plaintext of a token. The encrypted secret token itself (i.e., the ciphertext) may not necessarily need to be hidden from an adversary or malware, since the encryption limits how the token can be reused or may completely prevent its reuse. For such tokens, storing them in data memory may be acceptable rather than requiring them to only be embedded in instructions. Nevertheless, it may still be useful to employ additional mechanisms to keep the ciphertext secret as a defense-in-depth measure and to prevent reuse of the token. In another example, a secret token may not be encrypted. Instead, the plaintext may be embedded directly in the application and various other suitable mechanisms can be used to keep the plaintext secret.

Non-secret tokens may also be protected from discovery and/or unauthorized use. Although non-secret tokens are not encrypted, they may be authenticated in some embodiments. For authenticated non-secret tokens, the plaintext may not be kept secret, since the token is accompanied by a message authentication code that limits how that token can be reused. The message authentication code can be used to check the authenticity of the token. In at least some embodiments, however, it may still be useful to employ additional mechanisms to keep the plaintext and/or associated message authentication code secret as a defense-in-depth measure and to prevent reuse of the token. In another example, some embodiments may use unauthenticated non-secret tokens. Although unauthenticated non-secret tokens may not be kept secret, they may still be protected from unauthorized use. For example, the loader and/or operating system can restrict where each token is placed and control flow integrity can be implemented to prevent the application from being able to generate new tokens dynamically.

In an embodiment, authorizing a code region of an application to access a resource includes embedding one or more tokens into the code region as one or more immediate values in instructions within that code region. The immediate values can be secret or non-secret tokens that are protected from discovery and/or unauthorized use. The term ‘immediate value’ includes a constant operand encoded in an instruction of the code of the application or process.

In this embodiment, a sequence of instructions can be placed (e.g., by the compiler) before a segment load instruction, which loads a segment descriptor of a resource into a segment register. One or more instructions in the sequence can contain an immediate value, and one or more instructions in the sequence may be computation instructions (e.g., arithmetic, bit manipulation, etc.). The computation instructions can operate on registers to compute an authentication value based on the one or more immediate values. Depending on the type of tokens embedded in the instructions, appropriate operations can be performed (e.g., decryption, authentication with a message authentication code, etc.) to obtain the values to be used in the computation. The segment load instruction could be configured to verify, during execution of the application, that a certain register (e.g., a fixed register or a register specified by an instruction operand in the segment load instruction) contains an authentication value and that the authentication value corresponds to an expected value. If the verification is successful, the segment load instruction allows access to the resource via the segment descriptor.

By way of example, but not of limitation, assume a sequence of instructions is added to a code region to authorize the code region to access a particular resource. Two instructions in the sequence may each load a 32-bit immediate value into two separate registers (e.g., registers 131), and those instructions may be followed by other instructions in the sequence that combine the values in the registers into a 64-bit value in a single register. The value in the single register can serve as the authentication value, which can be compared to an expected value to verify that the code region is authorized to access the resource.

In another embodiment, authorizing a code region to access a resource can include embedding a token directly into a segment load instruction for the resource. For example, a segment load instruction can be extended to accept an immediate value as an operand in the new space of the instruction, and the token can be placed there directly. This immediate operand can be a secret or non-secret token that is protected from discovery and/or unauthorized use. The plaintext of the token can serve as the authentication value for the code region, and can be used during execution to verify that the code region is authorized to access the resource. Depending on the type of tokens embedded in the instructions, appropriate operations can be performed (e.g., decryption, authentication with a message authentication code, etc.) to obtain the plaintext of the token.

In embodiments that use encrypted secret tokens, various techniques may be used to derive an authentication value from the encrypted secret tokens. If an encrypted secret token is embedded in a segment load instruction, an authentication value may be derived by decrypting the token. If one or more encrypted secret tokens are stored in one or more instructions placed prior to a segment load instruction, the authentication value can be derived by decrypting the one or more tokens to obtain decrypted values and performing computations on the decrypted values. Additional techniques may be used in the decryption process to provide further protections for the tokens. For example, the identity of the code region (e.g., the code segment selector, the TSS selector, or a hash of the code region) can be incorporated as inputs into a decryption function so that the validity of the encrypted token depends on which code region contains that token. Consequently, malware that steals an encrypted token from one code region is unable to use that token in another code region. Furthermore, additional inputs such as the memory address of the token or the memory address of the instruction that uses the token to request access to a resource or a segment descriptor could also be incorporated as inputs into the decryption function to further constrain where a particular encrypted token can be used.

Alternatively, some embodiments may use authenticated non-secret tokens. If an authenticated non-secret token is embedded in a segment load instruction, an authentication value may be derived by authenticating the token using a corresponding message authentication code that accompanies the token. If one or more authenticated non-secret tokens are stored in one or more instructions placed prior to a segment load instruction, an authentication value may be derived by authenticating the one or more tokens using corresponding message authentication codes that accompany the tokens and performing computations on the authenticated tokens. A message authentication code could be generated over a message that incorporates its token and other elements (e.g., the code region identity, the memory address of the token, or the memory address of the instruction that uses the token to request access to a resource or a segment descriptor). Such techniques rely on a key that is inaccessible to malware. For example, this could be a per-CPU key or a per-program key that is installed into a write-only CPU register.

In at least some embodiments, non-secret tokens may be used if the operating system (OS) can approve code that is granted execute permission and can inspect each new executable code region to make sure it only contains acceptable access tokens. Control flow integrity could be enforced, so that unintended tokens do not occur within the executable code. Thus, no new tokens can be created after load time of the application. In at least one embodiment, policy engine 119 and policy store 139 may be used by the operating system to evaluate the code regions and determine whether the authorized code regions conform to a policy. When processor 110 sets a code region of an application to execute (e.g., during load time), processor 110 may not allow the application to execute if the code region does not conform to a policy. For example, an OS may want to ensure that a single function in a web server application has access to a private key for that server. Thus, in this non-limiting example, a policy allowing only the function performing cryptographic operations based on that private key to access that key is enforced.

In at least one embodiment, non-secret tokens could specify information that is ordinarily placed in privileged data structures. For example, if the OS controls and approves the tokens that occur within code, a token could directly specify the region of physical memory that can be accessed by the associated instructions. This could improve efficiency by avoiding the need for referencing privileged data structures. Another example is that the token could directly specify data to be loaded into a segment register, so that the associated access permissions could be used by one or more subsequent memory access instructions that reference that segment register.

An expected value can be used during execution of an application to verify that a code region is authorized to access a particular resource. In one example, the expected value can be stored in each segment descriptor of segment load instructions for the resource in currently unused fields or in newly-defined fields if the descriptor size is expanded to accommodate them. In another embodiment, storage structures for access policies (e.g., access tables 137) could be defined to associate segment descriptors to the expected values that grant access to them. The authorization of a code region to access a particular resource can be verified based on a comparison of an expected value to an authentication value derived from the code region. Depending on the implementation, the authentication value could be derived from an immediate operand in a segment load instruction or from one or more immediate values in a sequence of instructions. Success of the comparison can be based on the authentication value either directly or indirectly corresponding to the particular expected value to which it is compared.

To help keep malware from jumping to an unintended entry point in the token-loading sequence and obtaining a partial or full token, entry points to a portion of code containing an authorized segment load instruction can be controlled using any suitable technique based on particular needs and implementations. One technique, for example, includes placing just that code in a code region that can only be entered at a defined address.

In a further embodiment, authorizing a code region to access a particular resource can be based on an identity of the code region. In this scenario, the code region can be marked in a storage structure for access policies or in the descriptor of the resource to indicate that the code region is authorized to access the resource. For example, a code segment selector, a task state segment (TSS) selector, or a hash (e.g., SHA-256, etc.) of the contents of a code region could be stored in existing or new segment descriptor fields of a descriptor selected by a segment load instruction for the resource, or in secondary storage structures (e.g., access tables 137) to indicate that the code region is authorized to use the segment descriptor. The segment load instruction could be configured to verify, during execution, that the currently active code segment or TSS, or a hash of the currently active code region, corresponds to an authorized code region identity (e.g., selector or hash) stored in the resource descriptor selected by the segment load instruction or in the secondary storage structure (e.g., access tables 137).

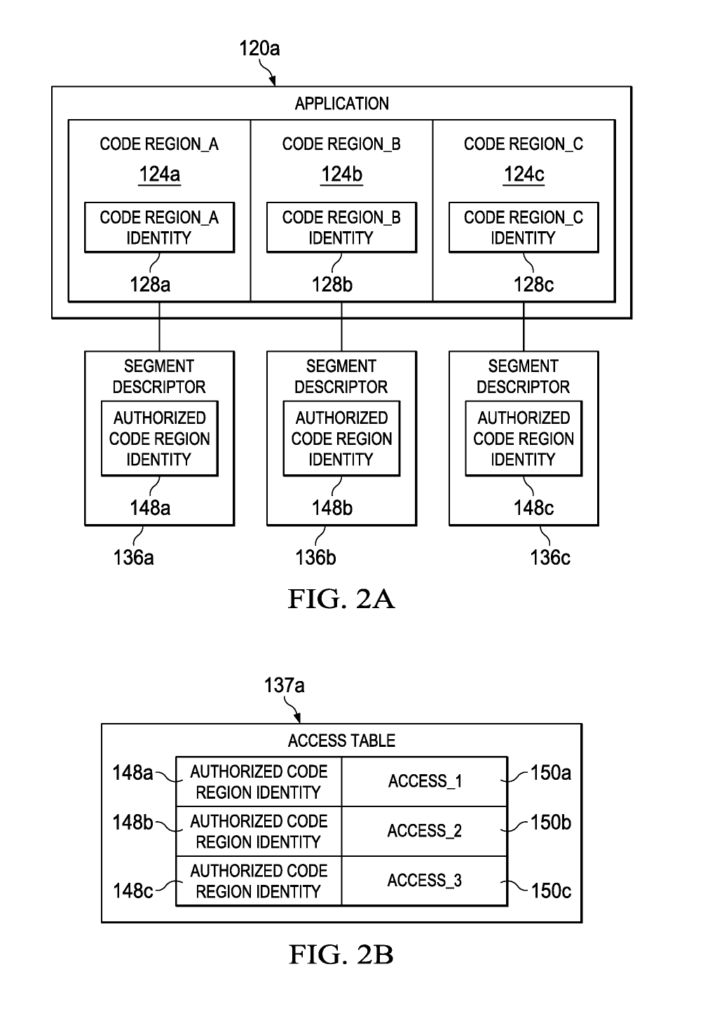

Turning to FIG. 2A, FIG. 2A is a simplified block diagram illustrating example details of a portion of a communication system providing access control, in accordance with an embodiment of the present disclosure using code region identities. As illustrated in FIG. 2A, application 120a can include code region_A 124a, code region_B 124b, and code region_C 124c. Code region_A 124a could include code region_A identity 128a. Code region_B 124b could include code region_B identity 128b. Code region_C 124c could include code region_C identity 128c. Various techniques may be used to determine a code region identity during execution of the code region including, but not limited to, determining the currently-active code segment selector, determining the TSS task selector, or determining a hash (e.g., SHA-256, etc.) of the contents of the code region.

In the example, each code region includes code to access a resource and loads a segment descriptor of the resource into a segment register. Code region_A 124a loads segment descriptor 136a, which identifies a resource to be accessed by code region_A 124a. Code region_B 124b loads segment descriptor 136b, which identifies a resource to be accessed by code region_B 124b. Code region_C 124c loads segment descriptor 136c, which identifies the resource to be accessed by code region_C 124c. The resources to be accessed by the code regions may be the same or different resources with the same or different types of access allowed.

During execution of a code region, an identity associated with the currently active code region can be determined. A segment descriptor loaded by the code region can include an authorized code region identity indicating a code region that is authorized to use the segment descriptor to access to a resource. If the determined code region identity of the currently active code region corresponds to the authorized code region identity in the segment descriptor, this correspondence verifies that the code region is authorized to use the segment descriptor to access the resource. For example, if code region identity_A 128a corresponds to authorized code region identity 148a, then it is verified that code region_A 124a is authorized to access the resource identified by segment descriptor 136a. If code region identity_B 128b corresponds to authorized code region identity 148b, then it is verified that code region_B 124b is authorized to access the resource identified by segment descriptor 136b. If code region identity_C 128c corresponds to authorized code region identity 148c, then it is verified that code region_C 124c is authorized to access the resource identified by segment descriptor 136c.

Turning to FIG. 2B, FIG. 2B is a simplified block diagram illustrating example details of a portion of a communication system providing access control, in accordance with another embodiment using code region identities. FIG. 2B illustrates an alternative embodiment to using segment descriptors for storing authorized code region identities as shown in FIG. 2A. As illustrated in FIG. 2B, access table 137a can indicate the types of access that are allowed for authorized code regions to access resources based on their code region identities. Segment descriptors of resources and/or types of access that are provided by the segment descriptors can be mapped to authorized code region identities that grant access to the segment descriptors.

For example, assume the same resource is to be accessed by each code region. Authorized code region identity 148a can grant access_1 150a to code region_A 124a if code region_A identity 128a corresponds to authorized code region identity 148a in access table 137a. Access_1 150a may indicate a segment descriptor that provides a high amount of access to the resource in one example. Authorized code region identity 148c can grant access_3 150c to code region_C 124c if code region_C identity 128c corresponds to authorized code region identity 148c in access table 137a. Access_3 150c may indicate a segment descriptor that provides a low amount of access to the resource in one example. Authorized code region identity 148b can grant access_2 150b to code region_B 124b if code region_B identity 128b corresponds to authorized code region identity 148b in access table 137a. Access_2 150b may indicate a segment descriptor that provides an amount of access to the resource that is between access_1 150a and access_3 150c. Although FIG. 2B is described with reference to varying types of access for different code regions to access the same resource, it will be apparent that access table 137a could also indicate segment descriptors and/or types of access for other resources to be accessed by the same (or different) code regions in the application.

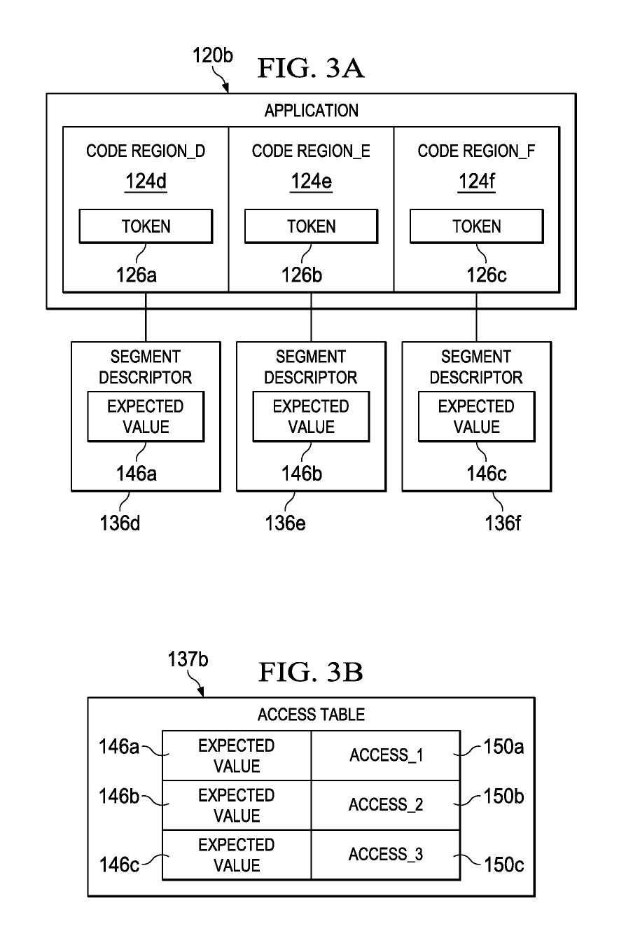

Turning to FIG. 3A, FIG. 3A is a simplified block diagram illustrating example details of a portion of a communication system providing access control, in accordance with an embodiment of the present disclosure using tokens. As illustrated in FIG. 3A, application 120b can include code region_D 124d, code region_E 124e, and code region_F 124f. Code region_D 124d could include an embedded token 126a. Code region_E 124e could include an embedded token 126b. Code region_F 124f could include an embedded token 126c. In at least one embodiment, the tokens could be embedded as immediate operands of segment load instructions for resources associated with the code regions. In another embodiment, each token could be embedded as an immediate value in an instruction added to the particular code region. Each token could be used, alone or with other tokens embedded in the same code region for the same resource, to compute an authentication value stored in a register.

In this example, each code region includes code to access a resource and loads a segment descriptor of the resource into a segment register. Code region_D 124d loads segment descriptor 136d, which identifies the resource to be accessed by code region_D 124d. Code region_E 124e loads segment descriptor 136e, which identifies the resource to be accessed by code region_E 124e. Code region_F 124f loads segment descriptor 1361, which identifies the resource to be accessed by code region_F 124f.

During execution of a code region, an authentication value can be derived based on the embedded token (or tokens) of the code region. A segment descriptor loaded by the code region can include an expected value and, when the expected value corresponds to the authentication value, this correspondence verifies that the code region is authorized to use the segment descriptor to access the resource. For example, if an authentication value derived based on token 126a corresponds to an expected value 146a in segment descriptor 136d, then it is verified that code region_D 124d is authorized to access the resource identified by segment descriptor 136d. If an authentication value derived based on token 126b corresponds to an expected value 146b in segment descriptor 136e, then it is verified that code region_E 124e is authorized to access the resource identified by segment descriptor 136e. If an authentication value derived based on token 126c corresponds to expected value 146c, then it is verified that code region_F 124f is authorized to access the resource identified by segment descriptor 136f.

It should be apparent that FIGS. 2A and 3A are simplified for illustration purposes and that each code region could load multiple segment descriptors corresponding to respective resources to be accessed by that code region. Additionally, each segment descriptor can indicate a particular type of access (e.g., read only, read and write, etc.) that is allowed for the resource it identifies. In some instances, different segment descriptors can identify the same resource but indicate different types of access that are allowed. Furthermore, each code region is shown with a single embedded token, but it should be apparent that multiple tokens may be embedded in a single code region in some scenarios, such as when multiple tokens are embedded in a sequence of instructions inserted prior to a segment load instruction.

Turning to FIG. 3B, FIG. 3B is a simplified block diagram illustrating example details of a portion of a communication system providing access control, in accordance with another embodiment using tokens. FIG. 3B illustrates an alternative embodiment to using segment descriptors for storing expected values as shown in FIG. 3A. As illustrated in FIG. 3B, access table 137b can indicate the types of access that are allowed for authorized code regions to access a resource. Segment descriptors and/or types of access that are provided by the segment descriptors can be mapped to expected values that grant access to the segment descriptors of the resources.

For example, assume the same resource is to be accessed by each code region. Expected value 146a can grant access_1 150a to code region_D 124d if an authentication value derived based on token 126a corresponds to expected value 146a in access table 137b. Access_1 150a may indicate a segment descriptor that provides a high amount of access to the resource in one example. Expected value 146c can grant access_3 150c to code region_F 124f if an authentication value derived based on token 126c corresponds to expected value 146c in access table 137b. Access_3 150c may indicate a segment descriptor that provides a low amount of access to the resource in one example. Expected value 146b can grant access_2 150b to code region_E 124e if an authentication value derived based on token 126b corresponds to expected value 146b in access table 137b. Access_2 150b may indicate a segment descriptor that provides an amount of access to the resource that is between access_1 150a and access_3 150c.

It should be noted that, in the various embodiments described herein, one or more code region authorizations may provide a same or similar amount of access or a different amount of access for each code region that is authorized to access the same resource. For example, for two code regions that are authorized to access the same resource, one code region may be authorized for one type of access (e.g., read access) to a particular address range (e.g., address range 0-7) of the resource, whereas the other code region may be authorized for another type of access including, but not limited to, the following: (1) the same type of access to the resource, (2) a different type of access (e.g., read and write access) to the resource, (3) the same type of access to an overlapping address range (e.g., address range 0-3) of the resource, or (4) a different type of access to an overlapping address range of the resource.

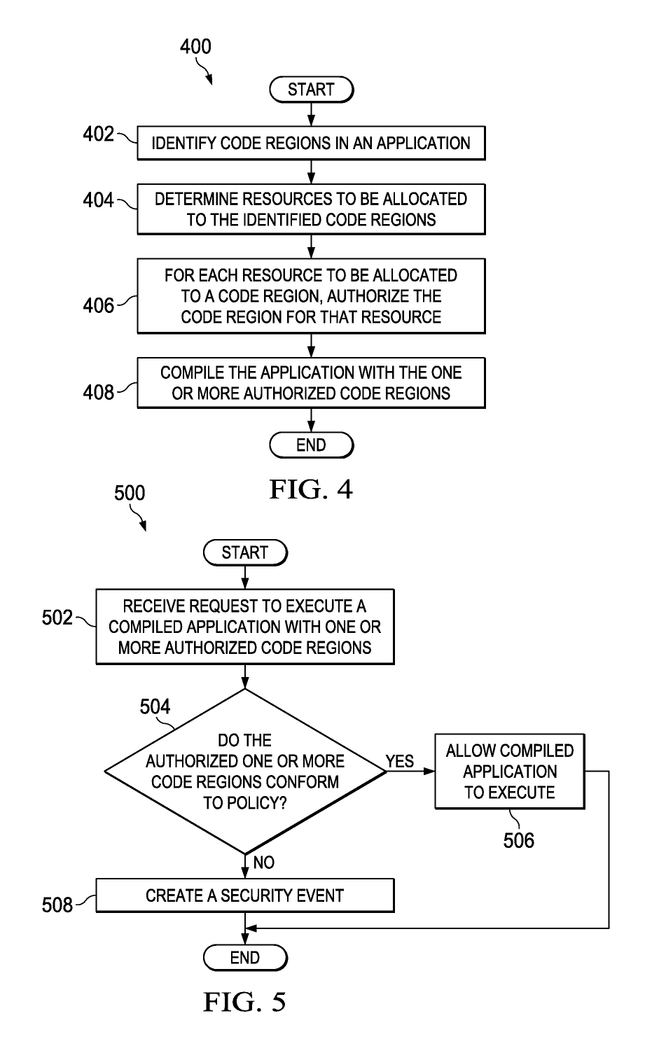

Turning to FIG. 4, FIG. 4 is an example flowchart illustrating possible operations of a flow 400 that may be associated with access control, in accordance with the present disclosure. In an embodiment, electronic device 102 comprises means, such as one or more processors (e.g., processor 110) for performing operations. At least some of the operations may be performed by access engine 113 and/or compiler 115 when executed by one or more processors such as processor 110.

At 402, code regions in an application are identified. One or more code regions can be identified in a single code segment of the application. Some applications may include multiple code segments and accordingly, one or more code regions can be identified in each of the code segments of the application. At 404, resources to be allocated to each of the identified code regions are determined.

At 406, for each resource to be allocated to an identified code region, the identified code region is authorized to access the resource. In one embodiment, a compiler authorizes an identified code region by embedding one or more tokens in the code region where the one or more tokens are associated with the resource to be accessed by the code region. For example, the one or more tokens can be embedded as immediate values in instructions within the code region. In another example, a token can be embedded as an immediate operand in a segment load instruction for the resource. An expected value, corresponding to an authentication value derived based on the one or more tokens, may be stored in a segment descriptor of the resource. Alternatively, an expected value may be stored in a storage structure (e.g., access table 137b) that associates a segment descriptor of the resource to the expected value that grants access to it. In a further embodiment, a compiler authorizes an identified code region by storing the identity of the code region in a segment descriptor of the resource, or in a storage structure (e.g., access table 137a) that associates the segment descriptor of the resource to the identity of the code region. At 408, the compiler compiles the application containing the one or more authorized code regions.

Turning to FIG. 5, FIG. 5 is an example flowchart illustrating possible operations of a flow 500 that may be associated with access control, in accordance with the present disclosure. In an embodiment, electronic device 102 comprises means, such as one or more processors (e.g., processor 110) for performing operations. At least some of the operations may be performed by policy engine 119, loader 117, and/or operating system 111 when executed by one or more processors such as processor 110.

At 502, a request is received to execute a compiled application with one or more authorized code regions. An example is a compiled application generated from the process described with reference to flow 400 of FIG. 4. The compiled code can be inspected. At 504, the system determines if one or more authorized code regions in the application conform to policies. More specifically, a determination can be made as to whether the resource assignments in the authorized code regions are consistent with policies (e.g., policy store 139) the operating system enforces. In one example scenario, an operating system may allow only one function in a web server application to have access to a private key for that server (e.g., private key used in SSL signature verification). The operating system can determine whether the one or more tokens associated with the private key resource are properly assigned to only the code region that needs access to that key. In an alternative embodiment, the operating system can determine whether an authorized code region identity is properly assigned to only the code region that needs access to that key. In another example, a specific code region may be determined to not conform to policies if an authentication value derived from a token assigned to the specific code region, or if a code region identity of the specific code region, indicates a full amount of access to a particular resource but the type of the specific code region should not have a full amount of access to the resource or the specific code region may be part of an application that would never have a full amount of access to the resource.

If a determination is made that each of the authorized code regions conforms to a policy, then the application is allowed to execute, as in 506. If any of the authorized code regions does not conform to a policy, then the code may not be allowed to execute, and at 508, a security event is created. For example, the security event may be to flag the application that includes the code region, to block the application, the code region or the code segment containing the code region from further access to the system, the application, to scan the code region or the code segment containing the code region for malware, etc.

In an alternative embodiment, code regions of an application may be authorized at load time when execution of the application is initiated, rather than at compile time. In this embodiment, for example, tokens may be embedded during flow 500 of FIG. 5. Embedding tokens at load time may be advantageous because certain mechanisms may be used to randomize the tokens. This may mitigate attempts by adversaries to guess tokens, since the tokens would be different each time the code runs, and the tokens would be absent from the stored executable file that may be readable by adversaries. Embedding tokens at load time rather than compile time could be particularly useful for non-secret, unauthenticated tokens if the tokens have some fixed meaning. For example, if tokens are segment selectors and the operating system has a particular algorithm for allocating segment descriptors, then the operating system may be configured to embed the corresponding selectors (tokens) at load time.

In some implementations, other operations described with reference to FIG. 4 may also be performed at load time. For example, code segments can be identified, code regions within each code segment can be identified, and resources to be allocated to the identified code regions can be determined during load time for the application. In other implementations, identifying code segments, identifying code regions, and determining resources can be performed during compile time for the application, while authorizing particular code regions (e.g., embedding tokens, storing authorized code region identities, etc.) can be performed during load time for the application.

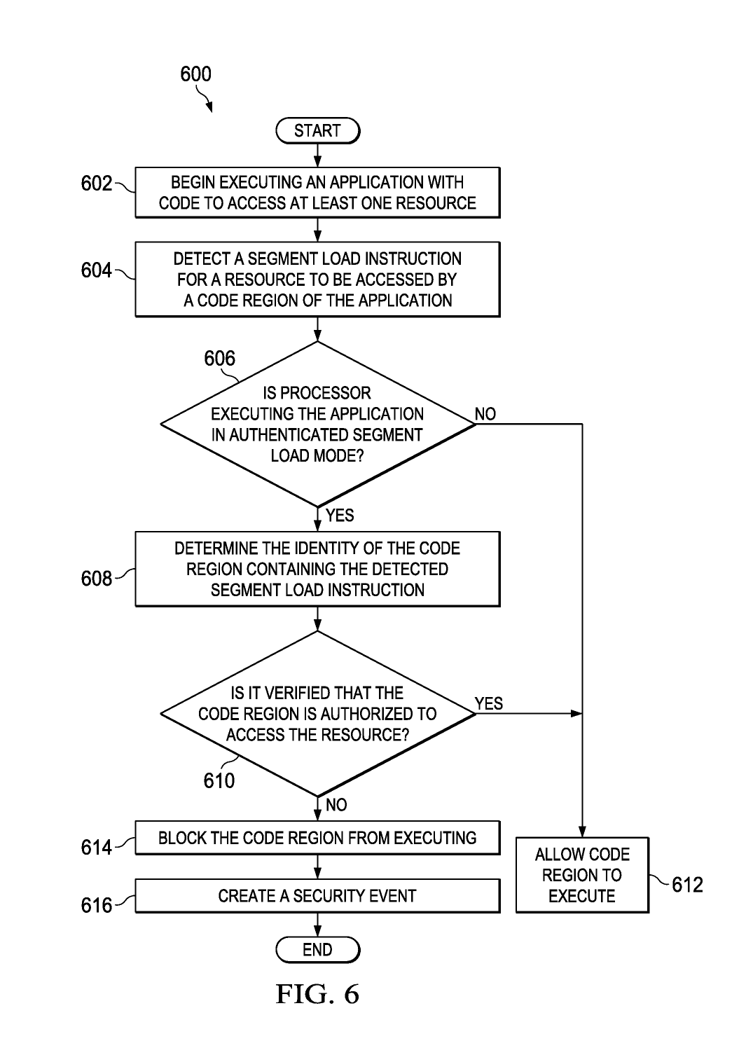

Turning to FIG. 6, FIG. 6 is an example flowchart illustrating possible operations of a flow 600 that may be associated with access control, in accordance with the present disclosure. In an embodiment, electronic device 102 comprises means, such as one or more processors (e.g., processor 110) for performing operations. At least some of the operations of flow 600 may be performed by processor 110. For example, the definition of segment load instructions may be configured such that the compiled code corresponding to the segment load instructions causes the processor to perform at least some of the operations of flow 600.

At 602, an application with code to access at least one resource begins executing. At 604, a segment load instruction for a code region is detected. For example, the segment load instruction can be detected when a segment register is being reloaded for a resource to be accessed by the code region. At 606, the system determines if a processor executing the application is in an authenticated segment load mode. If the processor is not in an authenticated segment load mode, then the code region is allowed to execute, as in 612.

lithe processor is in an authenticated segment load mode, then an identity of the code region containing the detected segment load instruction is determined, as in 608. The identity may be determined, for example, from a segment selector of the currently-active code segment, from a selector for the currently-active task state segment (TSS), or from a hash of the currently-active code region.

At 610, an attempt is made to verify that the code region is authorized to access the resource, based on the identity of the currently-active code region. In one example, this verification process can include determining whether the identity of the currently-active code region corresponds to an authorized code region identity (e.g., a segment selector, a TSS selector, a hash of a code region, etc.) stored in a segment descriptor selected by the segment load instruction to enable access to the resource. The authorized code region identity could be stored in currently unused fields or in newly-defined fields of the segment descriptor. In another example, this verification process can include determining whether the identity of the currently-active code region corresponds to an authorized code region identity (e.g., a code segment selector, a TSS selector, a hash of a code region, etc.) stored in a storage structure (e.g., access tables 137). The storage structure could be defined to associate segment descriptors of resources, and/or the types of access that are provided by the segment descriptors, to the authorized code segment identities that grant access to the segment descriptors.

If the identity of the currently-active code region is determined to correspond to the authorized code segment identity that grants access to the segment descriptor of the resource, then it is verified that the code region is authorized to access the resource and the code region may be allowed to execute, as in 612. If the identity of the currently-active code region is determined to not correspond to the authorized code segment identity that grants access to the segment descriptor of the resource, then it is not verified that the code region is authorized to access the resource and the code region may be blocked from executing, as in 614. At 616, a security event is created. For example, the security event may be to flag the application that includes the code segment containing the code region, to block the code segment or code region from further execution, to scan the application, code segment, or code region for malware, etc.

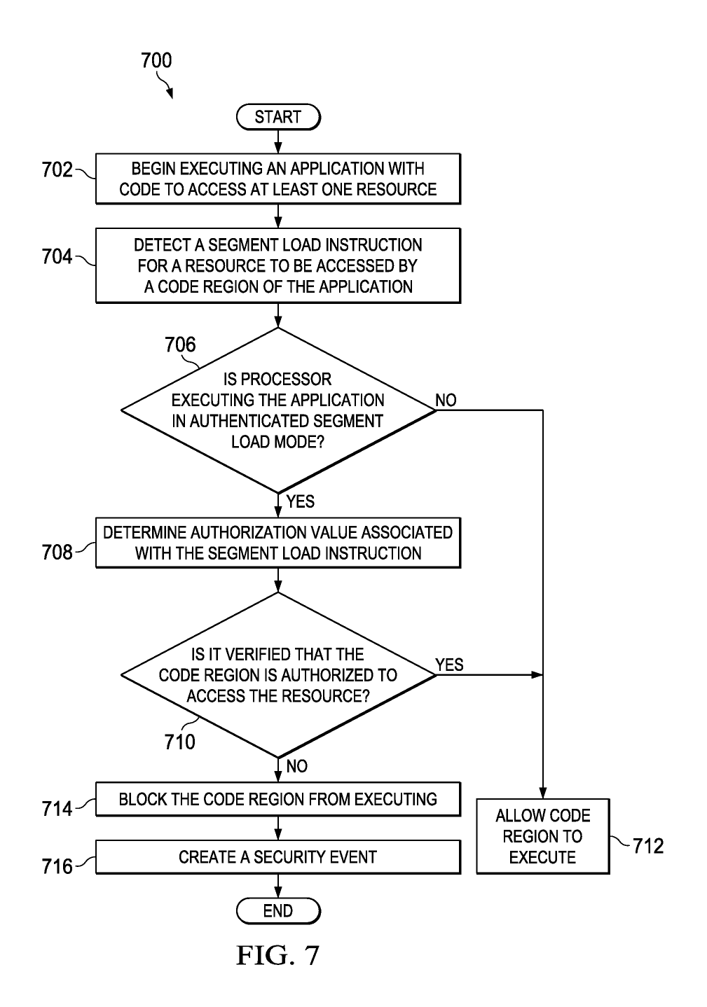

Turning to FIG. 7, FIG. 7 is an example flowchart illustrating possible operations of a flow 700 that may be associated with access control, in accordance with the present disclosure. In an embodiment, electronic device 102 comprises means, such as one or more processors (e.g., processor 110) for performing operations. At least some of the operations of flow 700 may be performed by processor 110. For example, the definition of segment load instructions may be configured such that the compiled code corresponding to segment load instructions causes the processor to perform at least some of the operations of flow 700.

At 702, an application with code to access at least one resource begins executing. At 704, a segment load instruction for a code region is detected. For example, the segment load instruction can be detected when a segment register is being reloaded for a resource to be accessed by the code region. At 706, the system determines if a processor executing the application is in an authenticated segment load mode. If the processor is not in an authenticated segment load mode, then the code region is allowed to execute, as in 712.

If the processor is in an authenticated segment load mode, then an authentication value associated with the segment load instruction is determined, as in 708. In one embodiment, the authentication value could be derived based on a single token embedded as an immediate value in an operand of the segment load instruction. In another embodiment, the authentication value could derived based on a single token or a combination of multiple tokens embedded as immediate values in a sequence of one or more instructions prior to the segment load instruction. The sequence of instructions can use a fixed register or a register specified by an instruction operand to compute the authentication value based on one token or multiple tokens embedded in the sequence of instructions.

At 710, an attempt is made to verify that the code region is authorized to access the resource based on the authentication value derived from the one or more tokens. In one example, this verification process can include determining whether the authentication value corresponds to an expected value stored in a segment descriptor selected by the segment load instruction to enable access to the resource. The expected value could be stored in currently unused fields or in newly-defined fields of the segment descriptor. In another example, this verification process can include determining whether the authentication value corresponds to an expected value stored in a storage structure (e.g., access tables 137). The storage structure could be defined to associate segment descriptors of resources, and/or the types of access that are provided by the segment descriptors, to the expected values that grant access to the segment descriptors.

If the authentication value is determined to correspond to the expected value that grants access to the segment descriptor of the resource, then it is verified that the code region is authorized to access the resource and the code region may be allowed to execute, as in 712. If the authentication value is determined to not correspond to the expected value that grants access to the segment descriptor of the resource, then it is not verified that the code region is authorized to access the resource and the code region may be blocked from executing, as in 714. At 716, a security event is created. For example, the security event may be to flag the application that includes the code segment containing the code region, to block the code segment or code region from further execution, to scan the application, code segment, or code region for malware, etc.

In another embodiment, a similar process could be used to selectively permit access to pages of memory by instructions when such accesses would ordinarily be blocked. The instruction could provide a token that is used to authorize access to the memory pages. The token could be a secret token or non-secret token that is protected from discovery and/or unauthorized use. The instruction could access the memory pages if authorization to override the normal page permissions is verified based on a comparison of an authentication value (e.g., derived from the secret token or non-secret token) to a specified policy (e.g., expected value). This could be used to selectively grant access to pages of memory containing privileged data structures.

In a further embodiment, a processor could be extended with new instructions that are specialized to update certain commonly-modified privileged data structures such as descriptor tables and page tables. For example, a ‘Write Descriptor Table Entry’ instruction could be defined that accepts a segment selector as an operand, a token used to authorize the instruction, and a new value for the descriptor table entry. The token could be a secret token or non-secret token that is protected from discovery and/or unauthorized use. The instruction could perform the specified update if an authentication value (e.g., derived from the secret token or non-secret token in the instruction) corresponds to a specified policy (e.g., an expected value). In another embodiment, the instruction could perform the specified update if an identity of a currently-active code region corresponds to a specified policy (e.g., an authorized code region identity). The code region identity could be determined by a currently active code segment selector, a TSS selector, or a hash of the code region as previously described herein. A similar instruction could be defined to update a page table entry at a specified level for a specified virtual address. Other system data structures such as Model-Specific Registers (MSRs) could be targeted similarly by other analogous instructions.

Additionally, access to descriptor table registers, control registers (e.g., CRO-8), and privileged instructions can be controlled in a similar manner. Examples of descriptor table registers include, but are not necessarily limited to, global descriptor table register (GDTR) and local descriptor table register (LDTR), which specify base addresses and sizes of a global descriptor table and local descriptor table, respectively. Access to these registers and privileged instructions can be authorized prior to execution of a code region (e.g., during compile time or load time) and then verified during execution of the code region based on an authentication value derived from one or more tokens or based on an identity of a currently-active code region, as previously explained herein.

This further embodiment for access control in updating privileged data structures can minimize or eliminate the need to invoke the operating system or virtual machine monitor to perform these page table entry updates, thus resulting in reduced overhead. For example, a private key is protected by being placed on a separate page of memory from other data, with that page normally marked as inaccessible. For illustration purposes, assume that only function A should be granted access to the data. A token could be embedded in an instruction at the beginning of function A that enables that instruction to modify the corresponding page table entry for the private key page. That instruction could mark the page as readable/accessible. Prior to function A transferring control out of itself, it could use another similar instruction to mark the page as inaccessible again. After each page table entry modification, the affected mappings could be invalidated to cause the new page table entry to be used for subsequent accesses. This general approach could be applied to either guest-level page tables or host-level (VMM-level) page tables in a virtualized system.

For illustration purposes, an example scenario that could occur in communication system 100 is now described. An application in this example scenario includes a code segment, an ordinary data segment (i.e., non-sensitive or less sensitive data), and a secret data segment that contains a cryptographic key. The code segment contains many functions in respective code regions, but only one function (e.g., Function A) in a particular code region is authorized to access the key. Function A has a controlled entrypoint to prevent malicious code from jumping into the middle of the function and resulting in a corrupted execution.

Instructions in Function A that need to access the key are preceded with an instruction to load a segment register with the selector for the secret data segment that contains that key. The selector is an index within a list of segment descriptors that the processor recognizes. The CPU provides various segment registers including a code segment (CS) register, a data segment (DS) register, a stack segment (SS) register, an extra segment (ES) register, etc. If ES register is used, then the ES register is loaded with the selector of the secret data segment. This can cause the processor to load the corresponding segment descriptor to grant access to the secret data segment that contains the key.

Before the processor performs the load of the descriptor, it can verify the authorization of the code region to access the resource. In this example, if a token is embedded as an immediate operand in the segment load instruction, an authentication value can be derived from the token and the processor can check whether the authentication value corresponds to an expected value. The expected value can be loaded from the segment descriptor in one example. In another example, the expected value can be loaded from a storage structure.

The segment descriptor specifies that, for any part of the application wanting to load this segment descriptor, that part of the application has to have an authentication value corresponding to this expected value. The segment load instruction can cause the processor to perform a check to make sure those values correspond either directly (e.g., exact same values) or indirectly (e.g., complementary, one can be derived from the other based on an operation, one is an encrypted value of the other, etc.). The immediate operand might be embedded as a secret token or non-secret token that is protected from discovery and/or unauthorized use, as previously described herein, so that an adversary cannot jump to some unintended entrypoint such as the embedded token or to some point in an instruction ahead of the embedded token and then try to extract that token.

After the segment register (e.g., ES register) is loaded, the instructions that load the key can access the segment containing the key. Additional instructions may also be provided to load the key out of that segment and operate on the key. When Function A has completed and wants to transfer control to some other function, it reloads that segment register with the ordinary data segment selector. Consequently, other functions are locked out of getting access to the cryptographic key, because those functions cannot access the data segment containing the key.

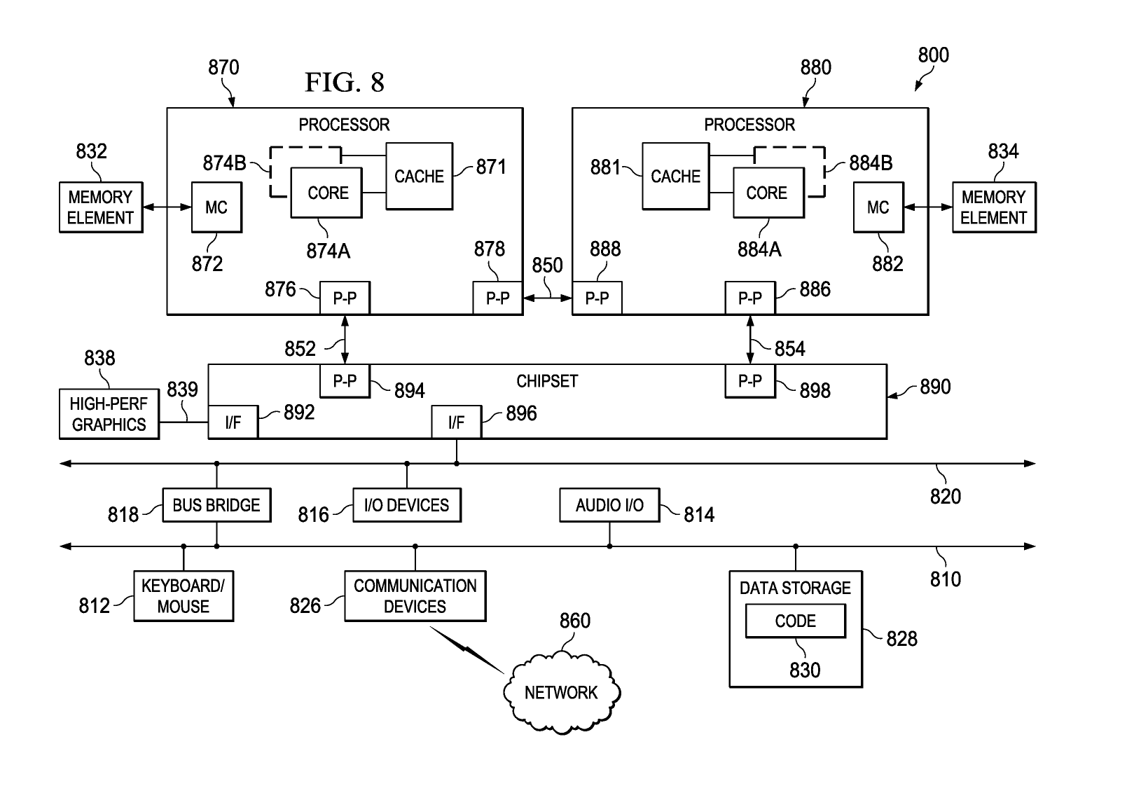

Turning to FIG. 8, FIG. 8 illustrates a computing system 800 that is arranged in a point-to-point (PtP) configuration according to an embodiment. In particular, FIG. 8 shows a system where processors, memory, and input/output devices are interconnected by a number of point-to-point interfaces. Generally, one or more of the network elements of communication system 100 may be configured in the same or similar manner as computing system 800.

As illustrated in FIG. 8, system 800 may include several processors, of which only two, processors 870 and 880, are shown for clarity. While two processors 870 and 880 are shown, it is to be understood that an embodiment of system 800 may also include only one such processor. Processors 870 and 880 may each include a set of cores (i.e., processor cores 874A and 874B and processor cores 884A and 884B) to execute multiple threads of a program. The cores may be configured to execute instruction code in a manner similar to that discussed above with reference to FIGS. 1-7. Each processor 870, 880 may include at least one shared cache 871, 881. Shared caches 871, 881 may store data (e.g., instructions) that are utilized by one or more components of processors 870, 880, such as processor cores 874 and 884.

Processors 870 and 880 may also each include integrated memory controller logic (MC) 872 and 882 to communicate with memory elements 832 and 834. Memory elements 832 and/or 834 may store various data used by processors 870 and 880. In alternative embodiments, memory controller logic 872 and 882 may be discreet logic separate from processors 870 and 880.

Processors 870 and 880 may be any type of processor and may exchange data via a point-to-point (PtP) interface 850 using point-to-point interface circuits 878 and 888, respectively. Processors 870 and 880 may each exchange data with a chipset 890 via individual point-to-point interfaces 852 and 854 using point-to-point interface circuits 876, 886, 894, and 898. Chipset 890 may also exchange data with a high-performance graphics circuit 838 via a high-performance graphics interface 839, using an interface circuit 892, which could be a PtP interface circuit. In alternative embodiments, any or all of the PtP links illustrated in FIG. 8 could be implemented as a multi-drop bus rather than a PtP link.

Chipset 890 may be in communication with a bus 820 via an interface circuit 896. Bus 820 may have one or more devices that communicate over it, such as a bus bridge 818 and I/O devices 816. Via a bus 810, bus bridge 818 may be in communication with other devices such as a keyboard/mouse 812 (or other input devices such as a touch screen, trackball, etc.), communication devices 826 (such as modems, network interface devices, or other types of communication devices that may communicate through a computer network 860), audio I/O devices 814, and/or a data storage device 828. Data storage device 828 may store code 830, which may be executed by processors 870 and/or 880. In alternative embodiments, any portions of the bus architectures could be implemented with one or more PtP links.

The computer system depicted in FIG. 8 is a schematic illustration of an embodiment of a computing system that may be utilized to implement various embodiments discussed herein. It will be appreciated that various components of the system depicted in FIG. 8 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

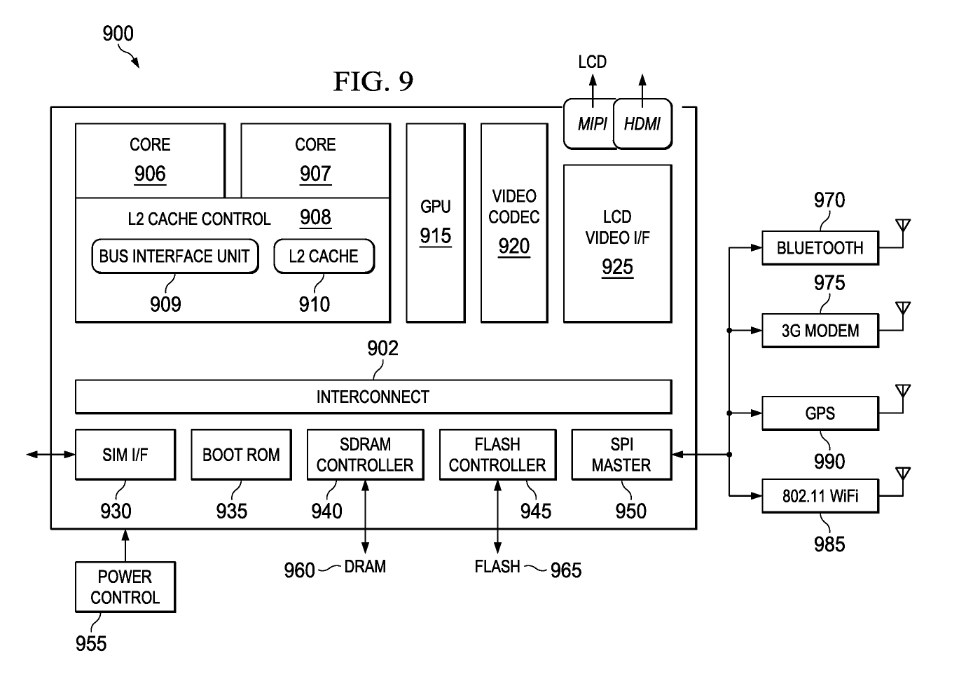

Turning to FIG. 9, FIG. 9 is a simplified block diagram associated with an example SOC 900 of the present disclosure. At least one example implementation of the present disclosure can include the detection of malicious strings features discussed herein. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 9, SOC 900 may include multiple cores 906-907, an L2 cache control 908, a bus interface unit 909, an L2 cache 910, a graphics processing unit (GPU) 915, an interconnect 902, a video codec 920, and a liquid crystal display (LCD) I/F 925, which may be associated with mobile industry processor interface (MIPI)/high-definition multimedia interface (HDMI) links that couple to an LCD.

SOC 900 may also include a subscriber identity module (SIM) I/F 930, a boot read-only memory (ROM) 935, a synchronous dynamic random access memory (SDRAM) controller 940, a flash controller 945, a serial peripheral interface (SPI) master 950, a suitable power control 955, a dynamic RAM (DRAM) 960, and flash 965. In addition, one or more example embodiments include one or more communication capabilities, interfaces, and features such as instances of Bluetooth™ 970, a 3G modem 975, a global positioning system (GPS) 980, and an 802.11 Wi-Fi 985.

In operation, the example of FIG. 9 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

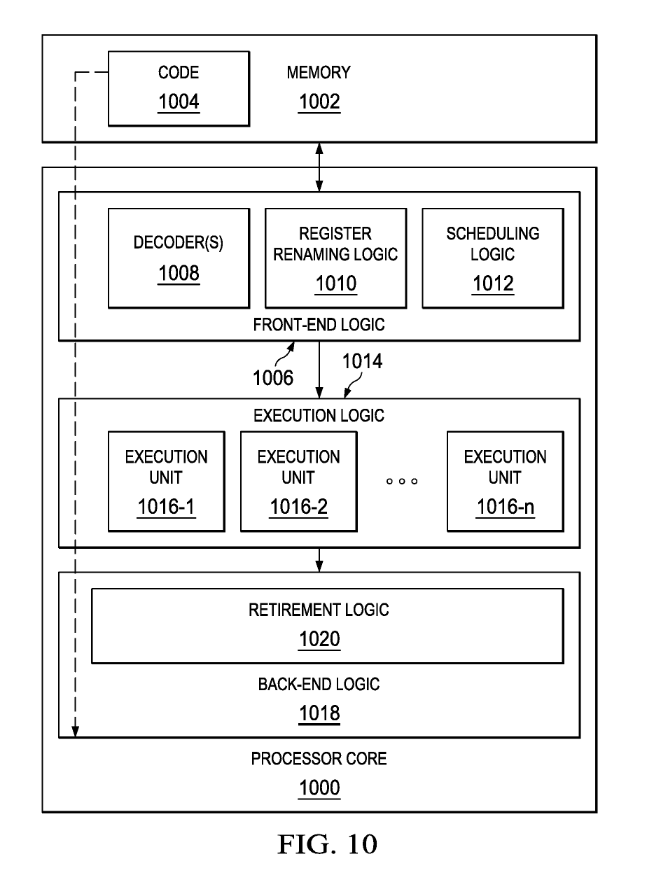

Turning to FIG. 10, FIG. 10 illustrates a processor core 1000 according to an embodiment. Processor core 1000 may be the core for any type of processor, such as a micro-processor, an embedded processor, a digital signal processor (DSP), a network processor, or other device to execute code. Although only one processor core 1000 is illustrated in FIG. 10, a processor may alternatively include more than one of the processor core 1000 illustrated in FIG. 10. For example, processor core 1000 represents one example embodiment of processors cores 1074a, 1074b, 1084a, and 1084b shown and described with reference to processors 1070 and 1080 of FIG. 10. Processor core 1000 may be a single-threaded core or, for at least one embodiment, processor core 1000 may be multithreaded in that it may include more than one hardware thread context (or “logical processor”) per core.

FIG. 10 also illustrates a memory 1002 coupled to processor core 1000 in accordance with an embodiment. Memory 1002 may be any of a wide variety of memories (including various layers of memory hierarchy) as are known or otherwise available to those of skill in the art. Memory 1002 may include code 1004, which may be one or more instructions, to be executed by processor core 1000. Processor core 1000 can follow a program sequence of instructions indicated by code 1004. Each instruction enters a front-end logic 1006 and is processed by one or more decoders 1008. The decoder may generate, as its output, a micro operation such as a fixed width micro operation in a predefined format, or may generate other instructions, microinstructions, or control signals that reflect the original code instruction. Front-end logic 1006 also includes register renaming logic 1010 and scheduling logic 1012, which generally allocate resources and queue the operation corresponding to the instruction for execution.

Processor core 1000 can also include execution logic 1014 having a set of execution units 1016-1 through 1016-N. Some embodiments may include a number of execution units dedicated to specific functions or sets of functions. Other embodiments may include only one execution unit or one execution unit that can perform a particular function. Execution logic 1014 performs the operations specified by code instructions.

After completion of execution of the operations specified by the code instructions, back-end logic 1018 can retire the instructions of code 1004. In one embodiment, processor core 1000 allows out of order execution but requires in order retirement of instructions. Retirement logic 1020 may take a variety of known forms (e.g., re-order buffers or the like). In this manner, processor core 1000 is transformed during execution of code 1004, at least in terms of the output generated by the decoder, hardware registers and tables utilized by register renaming logic 1010, and any registers (not shown) modified by execution logic 1014.

Although not illustrated in FIG. 10, a processor may include other elements on a chip with processor core 1000, at least some of which were shown and described herein with reference to FIG. 10. For example, as shown in FIG. 10, a processor may include memory control logic along with processor core 1000. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. In particular, as previously discussed herein, the flows of FIGS. 4-7 may be performed at different times on different devices. For example, FIG. 4 may be performed to generate a compiled application with authorized code regions. When the application is executed, the loading and execution may occur on the same device (e.g., electronic device 102) or on a different device, virtual machine, etc. Furthermore, in other implementations, the flows o FIGS. 4-7 could be performed on the same device. Accordingly, the examples provided should not limit the scope or inhibit the broad teachings of communication system 100 as potentially applied to a myriad of other architectures.

As used herein, unless expressly stated to the contrary, use of the phrase ‘at least one of’ refers to any combination of the named items, conditions, or activities. For example, ‘at least one of X, Y, and Z’ is intended to mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms ‘first’, ‘second’, ‘third’, etc., are intended to distinguish the particular items (e.g., element, condition, module, activity, operation, etc.) they precede. Unless expressly stated to the contrary, the use of these terms is not intended to indicate any type of order, rank, importance, temporal sequence, or hierarchy of the items. For example, ‘first X’ and ‘second X’ are intended to designate two separate X elements that are not necessarily limited by any order, rank, importance, temporal sequence, or hierarchy of the two elements.

It is also important to note that the operations in the preceding flow diagrams (i.e., FIGS. 4-7) illustrate only some of the possible access control scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 has been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

The following examples pertain to embodiments in accordance with this specification. Example 1 provides an apparatus, a system, one or more machine readable storage mediums, a method, and/or hardware-, firmware-, and/or software-based logic for controlling access to memory, to: identify a code region of a code segment in an application, determine a resource to be allocated to the code region, and prior to the application executing, authorize the code region to access the resource during an execution of the code region.

In Example 2, the subject matter of Example 1 can optionally include where the authorizing the code region includes embedding at least one token in the code region.

In Example 3, the subject matter of any one of Examples 1-2 can optionally include where the authorizing the code region includes storing an expected value in either a segment descriptor of the resource or in a secondary storage structure.

In Example 4, the subject matter of any one of Examples 1-3 can optionally include where the authorizing the code region includes embedding a token as an immediate value in a segment load instruction associated with the resource.

In Example 5, the subject matter of any one of Examples 1-3 can optionally include where the authorizing the code region includes embedding one or more tokens as immediate values in one or more instructions, respectively, in the code region.

In Example 6, the subject matter of any one of Examples 5 can optionally include the executable logic, when executed by the at least one processor, causing the at least one processor to insert a sequence of instructions in the code region, where at least some of the instructions in the sequence, when executed by a processor, compute an authentication value based, at least in part, on the one or more tokens.

In Example 7, the subject matter of Example 6 can optionally include the authentication value being stored in a fixed register or a register specified by an instruction operand in a segment load instruction associated with the resource.

In Example 8, the subject matter of Example 1 can optionally include where the authorizing the code region includes associating an identity of the code region with the resource.

In Example 9, the subject matter of Example 8 can optionally include where the associating an identity of the code region with the resource includes storing the identity of the code region in one of a segment descriptor of the resource or in a secondary storage structure.

In Example 10, the subject matter of any one of Examples 8-9 can optionally include where the identity of the code region is based on one of a code segment selector for the code region, a task state segment (TSS) associated with the code region, or contents of the code region.

In Example 11, the subject matter of any one of Examples 1-10 can optionally include the code region being one of a plurality of code regions in the code segment.

In Example 12, the subject matter of any one of Examples 1-11 can optionally include the code segment being one of a plurality of code segments in the application.

In Example 13, the subject matter of any one of Examples 1-12 can optionally include the executable logic, when executed by the at least one processor, causing the at least one processor to: determine one or more other resources to be allocated to the code region, and prior to the application executing, authorize the code region to access the one or more other resources during the execution of the code region.

In Example 14, the subject matter of any one of Examples 1-13 can optionally include, when the application is executed, a segment load instruction associated with the resource in the code region of the code segment to: attempt to verify the code region is authorized to access the resource, and allow the execution of the code region based, at least in part, on verifying the code region is authorized to access the resource.

In Example 15, the subject matter of any one of Examples 2-7 or 11-13 can optionally include, second executable logic, when executed by at least a second processor, is to: determine an authentication value based on the at least one embedded token in the code region, verify the code region is authorized to access the resource based, at least in part, on the authentication value, and allow execution of the code region based, at least in part, on verifying the code region is authorized to access the resource.

In Example 16, the subject matter of any one of Examples 8-13 can optionally include, second executable logic, when executed by at least a second processor, is to: determine the identity of the code region, verify the code region is authorized to access the resource based, at least in part, on the identity of the code region, and allow execution of the code region based, at least in part, on verifying the code region is authorized to access the resource.

In Example 17, the subject matter of any one of Examples 15-16 can optionally include a segment load instruction associated with the resource, the segment load instruction including at least a portion of the second executable logic.

Example 18 provides an apparatus for controlling access to memory, the apparatus comprising means for performing the method of any one of Examples 1-17.

In Example 19, the subject matter of Example 18 can optionally include the means for performing the method comprising at least one processor and at least one memory element.

In Example 20, the subject matter of Example 19 can optionally include the at least one memory element comprising machine readable instructions that when executed, cause the apparatus to perform the method of any one of Examples 1-17.

In Example 21, the subject matter of any one of Examples 18-20 can optionally include the apparatus being one of computing system or a system-on-a-chip.

Example 22 provides at least one machine readable storage medium comprising instructions for controlling access to memory, where the instructions when executed realize an apparatus or implement a method as in any one of Examples 1-17.

What is claimed is:

1. At least one machine readable medium comprising executable logic that when executed by at least one processor, causes the at least one processor to:
identify a code region of a code segment in an application;
determine a resource to be allocated to the code region; and
prior to the application executing, authorize the code region to access the resource during an execution of the code region.

2. The at least one machine readable medium of claim 1, wherein authorizing the code region includes embedding at least one token in the code region.

3. The at least one machine readable medium of claim 2, wherein authorizing the code region includes storing an expected value in either a segment descriptor of the resource or in a secondary storage structure.

4. The at least one machine readable medium of claim 1, wherein authorizing the code region includes embedding a token as an immediate value in a segment load instruction associated with the resource.

5. The at least one machine readable medium of claim 1, wherein authorizing the code region includes embedding one or more tokens as immediate values in one or more instructions, respectively, in the code region.

6. The at least one machine readable medium of claim 5, wherein the executable logic, when executed by the at least one processor, causes the at least one processor to:
insert a sequence of instructions in the code region, wherein at least some of the instructions in the sequence, when executed by a processor, compute an authentication value based, at least in part, on the one or more tokens.

7. The at least one machine readable medium of claim 6, wherein the authentication value is stored in a fixed register or a register specified by an instruction operand in a segment load instruction associated with the resource.

8. The at least one machine readable medium of claim 1, wherein authorizing the code region includes associating an identity of the code region with the resource.

9. The at least one machine readable medium of claim 8, wherein associating an identity of the code region with the resource includes storing the identity of the code region in one of a segment descriptor of the resource or in a secondary storage structure.

10. The at least one machine readable medium of claim 8, wherein the identity of the code region is based on one of a code segment selector for the code region, a task state segment (TSS) associated with the code region, or contents of the code region.

11. The at least one machine readable medium of claim 1, wherein the code region is one of a plurality of code regions in the code segment.

12. The at least one machine readable medium of claim 1, wherein the code segment is one of a plurality of code segments in the application.

13. The at least one machine readable medium of claim 1, wherein the executable logic, when executed by the at least one processor, causes the at least one processor to:
determine one or more other resources to be allocated to the code region;
prior to the application executing, authorize the code region to access the one or more other resources during the execution of the code region.

14. The at least one machine readable medium of claim 1, wherein, when the application is executed, a segment load instruction associated with the resource in the code region of the code segment is to:
attempt to verify the code region is authorized to access the resource; and
allow the execution of the code region based, at least in part, on verifying the code region is authorized to access the resource.

15. An apparatus for controlling access to memory, comprising:
logic, the logic at least partially comprising hardware logic to:
identify a code region of a code segment in an application;
determine a resource to be allocated to the code region; and
prior to the application executing, authorize the code region to access the resource during an execution of the code region.

16. The apparatus of claim 15, wherein authorizing the code region includes embedding at least one token in the code region.

17. The apparatus of claim 15, wherein authorizing the code region includes storing an expected value in either a segment descriptor of the resource or in a secondary storage structure.

18. The apparatus of claim 15, wherein authorizing the code region includes associating an identity of the code region with the resource.

19. A method for controlling access to memory, comprising:
identifying a code region of a code segment in an application;
determining a resource to be allocated to the code region; and
prior to the application executing, authorizing the code region to access the resource during an execution of the code region.

20. The method of claim 19, wherein authorizing the code region includes embedding one or more tokens as immediate values in one or more instructions, respectively, in the code region.

21. A system for controlling access to memory, comprising:
a first processor; and
first logic configured for execution by the first processor to:
identify a code region of a code segment in an application;
determine a resource to be allocated to the code region; and
prior to the application executing, authorize the code region to access the resource during an execution of the code region.

22. The system of claim 21, wherein authorizing the code region includes one of embedding at least one token in the code region or associating an identity of the code region with the resource.

23. The system of claim 22, further comprising:
a second processor; and
second logic configured for execution by the second processor to:
determine an authentication value based on the at least one embedded token in the code region;
verify the code region is authorized to access the resource based, at least in part, on the authentication value; and
allow execution of the code region based, at least in part, on verifying the code region is authorized to access the resource.

24. The system of claim 22, further comprising:
a second processor; and
second logic configured for execution by the second processor to:
determine the identity of the code region;
verify the code region is authorized to access the resource based, at least in part, on the identity of the code region; and
allow execution of the code region based, at least in part, on verifying the code region is authorized to access the resource.

25. The system of claim 24, wherein a segment load instruction associated with the resource includes at least a portion of the second logic.
